(19) United States
(12) Patent Application Publication
(10) Pub. No.: US 2006/0195890 A1
(43) Pub. Date: Aug. 31, 2006

(54) Authentication setting information notifying system

(75) Inventor: Isao Funaki, Kawasaki (JP)

Correspondence Address: STAAS & HALSEY LLP;JIM LIVINGSTON, SUITE 700, 1201 NEW YORK AVENUE, N.W., WASHINGTON, DC, 20005, US

(73) Assignee: Fujitsu Limited, Kawasaki (JP)

(21) Appl. No.: 11/235,234

(22) Filed: Sep. 27, 2005

(30) Foreign Application Priority Data
Feb. 28, 2005 (JP) JP2005-054802

(51) Int. Cl. H04L 9/32; H04L 9/00; H04K 1/00; G06K 9/00; G06F 17/30; G06F 15/16; G06F 7/04; G06F 7/58; G06K 19/00

(52) U.S. Cl. 726/4; 713/183; 713/186

(57) ABSTRACT

To enable security information at the startup time to be managed by other computer in a way that refers, after starting up a user information device, to a setting state of a password, then sets it as the security information and notifies a predetermined administrator information device of the security information. A user information device refers to a setting state of authentication of the user information device, and notifies a predetermined administrator device of a result of the reference as authentication setting information, and the administrator device receives and presents the authentication setting information to an administrator.

### BACKGROUND OF THE INVENTION

The invention relates to a technology of notifying a predetermined administration computer of security information of an information processing device (computer).

A basic method for ensuring security of a computer is that a basic input/output system (which will hereinafter be abbreviated to BIOS) acquires and authenticates a password when starting up the computer, thus judging validity of a user. Namely, the BIOS, if a valid password is inputted, continues a startup process and enables hardware configuring the computer to be used and, whereas if the valid password is not inputted, stops the startup process. The BIOS is the basic system for controlling the input and the output of data in the hardware configuring the computer, and hence, if set to start up after the BIOS has authenticated the password, the startup can be stopped before enabling the hardware to be used unless the valid password is inputted even when a third party tries to unlawfully employ, whereby the comparatively high security can be obtained.

Such being the case, there are some cases where a security policy is settled to set a request for the password when starting up the computer employed for business operations in enterprises, etc.

As the authentication is conducted before enabling the hardware such as a communication control unit, etc., to be used, therefore, there was a constraint that centralized management of the passwords is hard to handle via a network. Then, whether the setting is done or not is checked in, for instance, the following procedures:

(1) an administrator instructs the user to set the password,

(2) the user sets the password on the computer, and

(3) the administrator visually checks whether the user inputs the password or not when starting up the computer.

Further, the prior art related to the invention of the present application is a technology disclosed in, for example, Patent document 1 that follows.

[Patent document 1] Japanese Patent Application Laid-Open Publication No. 2003-67338

### SUMMARY OF THE INVENTION

As described above, however, the method of visually checking the input of the password involves increasing a burden on the administrator in proportion to the number of computers to be managed, and therefore the management gets difficult in the case of employing a multiplicity of computers.

Further, the administrator can not check if not at a timing when the user starts up the device, and there is a problem that there is a large constraint in time.

Under such circumstances, the invention provides a technology enabling security information at the startup time to be managed by other computer in a way that refers, after starting up an information processing device, to a setting state of a password, then sets it as security information and notifies a predetermined administrator device of the security information.

For solving the problems, the invention adopts the following configurations.

Namely, an authentication setting information notifying system of the invention, in which a user information device notifies an administrator information device of authentication setting information via a network,

the user information device comprising:

an authentication state referring module referring to a setting state of authentication of the user information device; and

a notifying module notifying a predetermined administrator device of a result of the reference as authentication setting information,

the administrator device comprising:

a receiving module receiving the authentication setting information; and

a presenting module presenting the authentication setting information to an administrator.

The user information device may further comprise:

an authentication module making authentication corresponding to the setting state of the authentication when started up; and

a startup control module executing a predetermined startup process when the authentication is conducted correctly by the authentication module.

The authentication module may make the authentication for a period till a communication by the notifying module is enabled to perform since an onset of the startup.

The authentication module and the startup control module may operate based on BIOS,

the startup control module may start up an OS through a predetermined startup process, and

the authentication state referring module and the notifying module may operate based on the OS or an application program running in cooperation with the OS.

The receiving module may receive the authentication setting information from the plurality of user information devices, and

the presenting module may aggregate the authentication setting information given from the plurality of user information devices and may present the aggregated information to the administrator.

The authentication of the user information device may be done corresponding to inputting a password of a user.

The authentication may be an updated state of the password.

The authentication of the user information device may be done based on biometric information of the user.

Moreover, according to the invention, a user information device for notifying an administrator information device of authentication setting information via a network, comprising:

an authentication state referring module referring to a setting state of authentication of the user information device; and

a notifying module notifying a predetermined administrator device of a result of the reference as authentication setting information.

For example, the authentication setting information notifying system is configured as a system that employs the user information device capable of setting the password on the BIOS, checks whether the password of the BIOS is set or not at a point of time when the startup of the user information device is initiated, and notifies the designated administrator information device of the result thereof by e-mail, etc.

With this contrivance, the setting state of the password of the user information device can be checked on the administrator information device via the network, and hence an administrator has no necessity of visually checking while being present at the startup of the user information device each time. Namely, it is possible to check the setting content at a convenient time without being restricted by the time when the user starts up the device.

Further, the user does not need to temporarily interrupt the startup of the device in order to check the BIOS password.

Moreover, An authentication setting information notifying method of the invention, executed by a user information device connected to an administrator information device via a network, comprising:

a step of referring to a setting state of authentication of the user information device; and

a step of notifying a predetermined administrator device of a result of the reference as authentication setting information.

The authentication setting information notifying method may further comprise steps of:

making authentication when started up, corresponding to the setting state of the authentication; and

executing a predetermined startup process when the authentication is conducted correctly.

Moreover, the invention may also be a program for making a computer execute the authentication setting information notifying method. Moreover, the invention may also be a readable-by-computer storage medium stored with this program. The computer is made to read and execute the program on this storage medium, whereby functions thereof can be provided.

Herein, the readable-by-computer storage medium connotes a storage medium capable of storing information such as data, programs, etc. electrically, magnetically, optically, mechanically or by chemical action, which can be read from the computer. Among these storage mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the storage mediums fixed within the computer.

According to the invention, it is possible to provide the technology enabling the security information at the startup time to be managed by other computer in a way that refers, after starting up the information processing device, to the setting state of the password, then sets it as the security information and notifies the predetermined administrator device of the security information.

### BRIEF DESCRIPTION OF THE DRAWINGS

FIG. 1 is a schematic view of a security information notifying system according to the invention.

FIG. 2 is a functional block diagram of a user terminal.

FIG. 3 is an explanatory diagram of a procedure of setting a password in BIOS.

FIG. 4 is an explanatory diagram of the procedure of setting the password in the BIOS.

FIG. 5 is a functional block diagram of an administrator terminal.

FIG. 6 is an explanatory diagram of a startup process of the user terminal.

FIG. 7 is an explanatory diagram of a setting state report process.

FIG. 8 is a diagram showing an example of a main screen.

FIG. 9 is a diagram showing an example of a result display screen.

FIG. 10 is a diagram showing an example of a transmission destination display screen.

FIG. 11 is an explanatory diagram of a security information receiving method.

### DETAILED DESCRIPTION OF THE PREFERRED EMBODIMENT

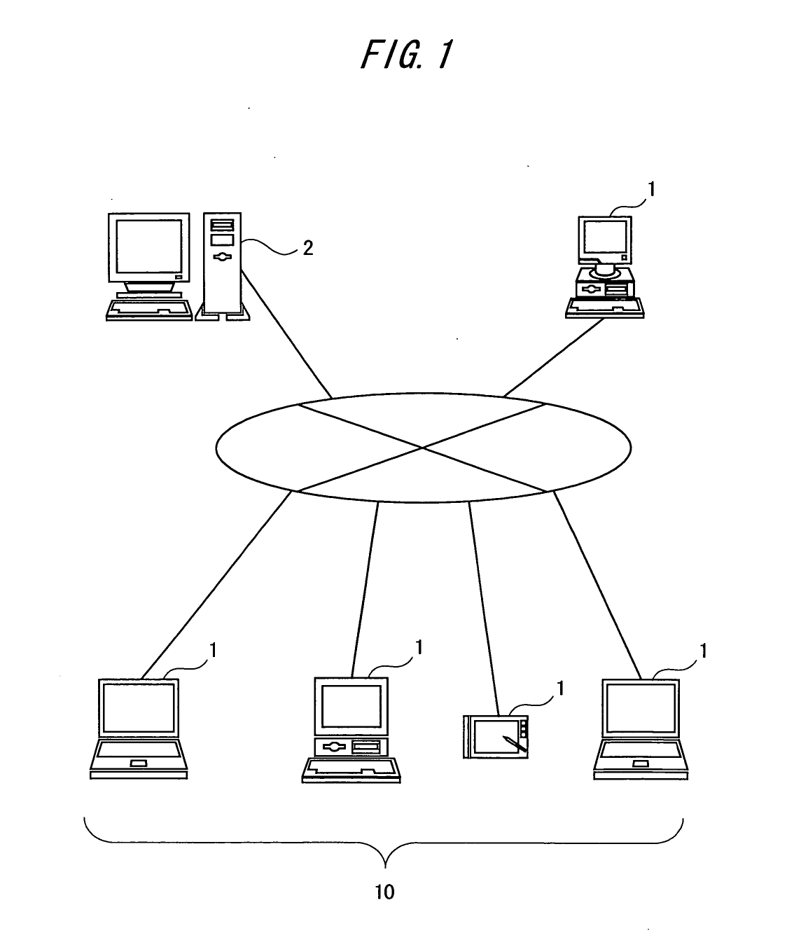

FIG. 1 is a schematic view of a security information notifying system (authentication setting information notifying system) according to the invention.

A security information notifying system 10 in this example is configured by a plurality of user terminals (user information devices) 1 and an administrator terminal (administrator information device) 2, which are connected via a network such as a LAN (Local Area Network), etc.

Each of the user terminals 1 is set to request a password when started up (booted) and executes, only when a valid password is inputted, a startup process to enable a user to use the terminal itself. Then, after the startup, the user terminal 1 refers to a setting state of the password and notifies the administrator terminal 2 of the setting state. In the system 10, an administrator gets thereby capable of performing centralized management of the setting states of the passwords via the network when the user terminals 1 are started up.

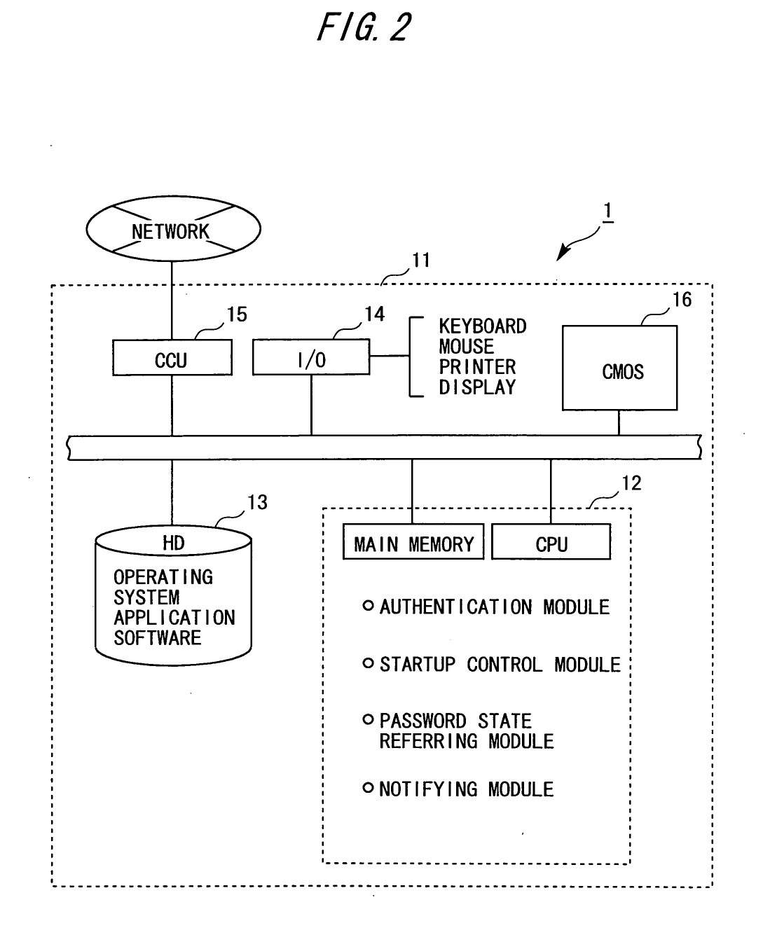

FIG. 2 is a schematic diagram of a configuration of the user terminal 1 in the embodiment. As shown in FIG. 2, the user terminal 1 is a general type of computer having a housing 11 that includes an arithmetic processing unit 12 constructed of a CPU (Central Processing Unit), a main memory, etc., a storage unit (hard disc) 13 stored with data and software for arithmetic processing, an I/O port 14, a communication control unit (CCU) 15, a CMOS 16, etc.

Input devices such as a keyboard, a mouse, a CD-ROM drive, etc., and output devices such as a display device, a printer, etc. are properly connected to the I/O ports 14.

The CCU 15 performs communications with other computers via a network.

The CMOS 16 is stored with a program as BIOS (Basic Input/Output System) and with setting information about an operation of the BIOS.

The storage unit 13 is preinstalled with an operating system (OS) and application software (security information notifying program).

The arithmetic processing unit 12 executes, when started up, startup processes such as reading the BIOS, authenticating the password, effecting POST (Power On Self Test), initializing the device, starting up the OS and so on. Through this operation, the arithmetic processing unit 12 functions as an authentication module and a startup control module according to the invention. Further, the arithmetic processing unit 12 properly reads the OS and the application program from the storage unit 13 and executes the OS and the application program, and effects the arithmetic processing upon pieces of information inputted from the I/O ports 14 and from the CCU 15 and information read from the storage unit 13, thereby functioning as the authentication module, the startup control module, a password state referring module and a notifying module.

The authentication module checks the setting state of the password when started up, and authenticates the password on the basis of this check.

The startup control module executes a predetermined startup process when the inputted password is authenticated, and, if the password is not authenticated, cancels the startup process.

The password state referring module refers to the setting state of the password in a sate where the startup process is completed and the OS is running.

The notifying module notifies the predetermined administrator device 2 of a result of the reference as security information via the network.

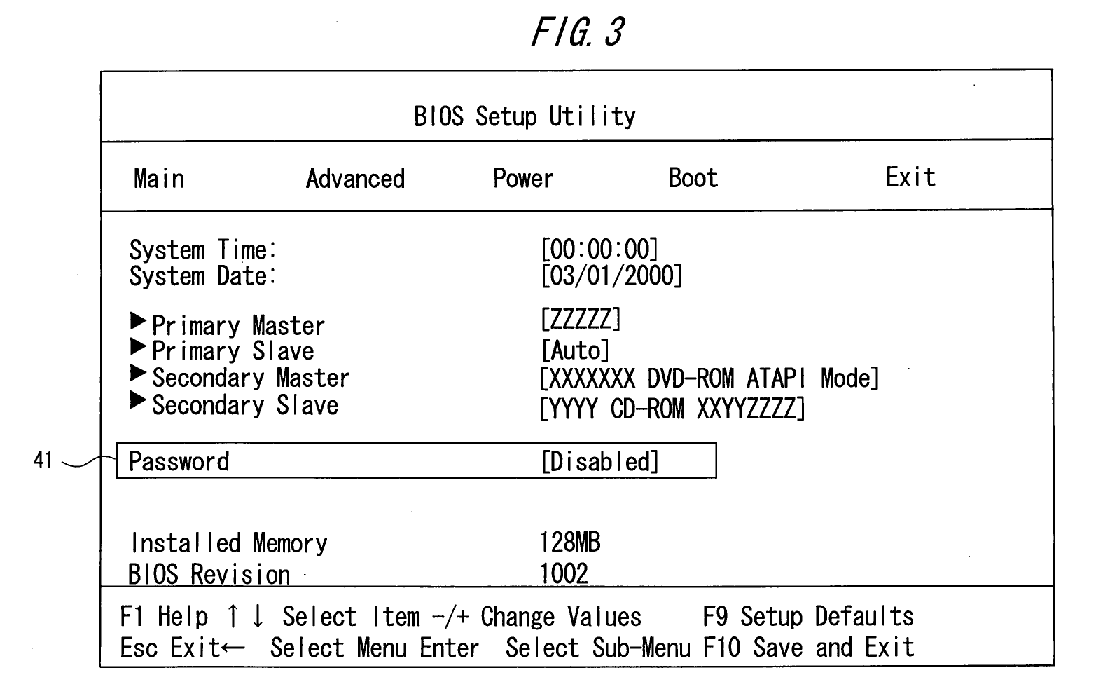

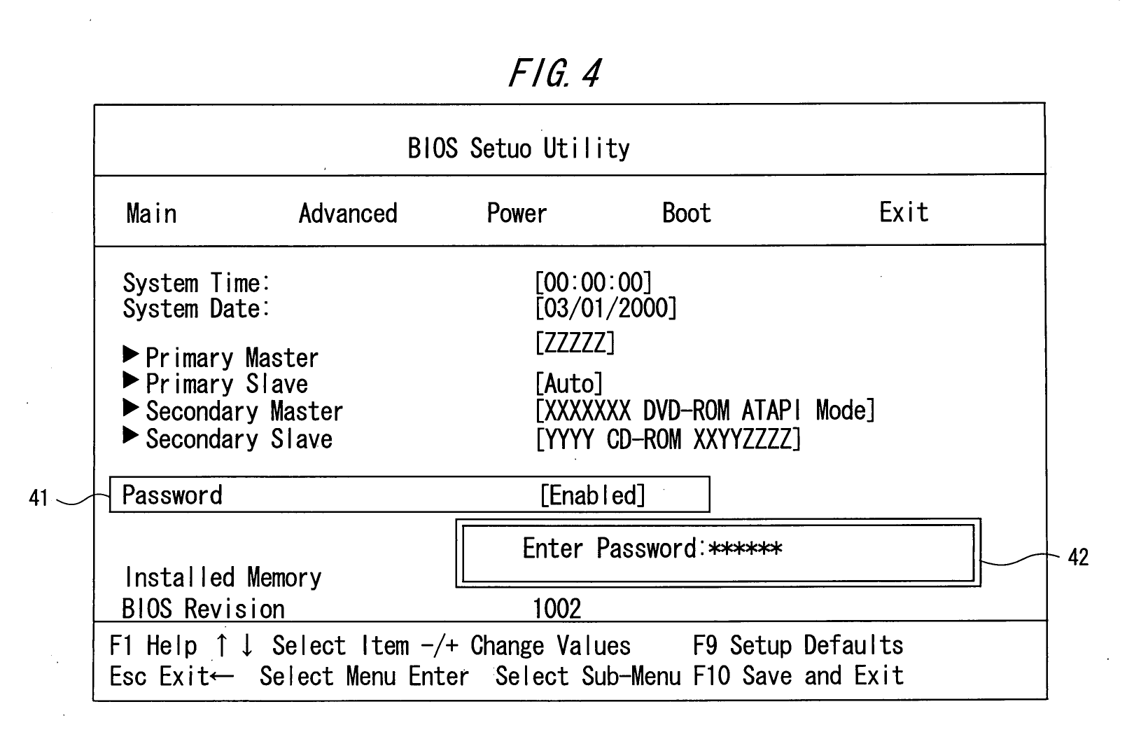

On the user terminal 1, a user opens a BIOS setup screen (FIG. 3) and previously sets up a content of the BIOS-based startup process. For instance, in the case of authenticating the password when started up, a password item 41 on the screen is turned enabled, and as shown in FIG. 4 the password is inputted into an input box 42. On the other hand, the user terminal 1 stores the CMOS with the inputted password. Note that the password may also be a user password, an administrator password, a supervisor password, a startup password and so on.

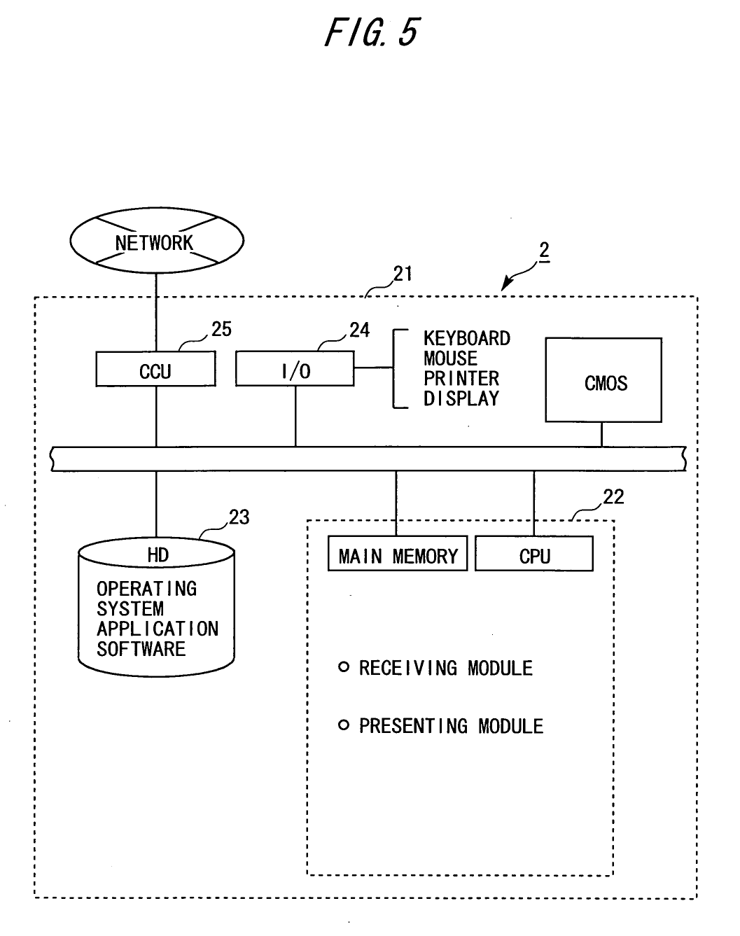

FIG. 5 is a schematic diagram of a configuration of the administrator terminal 2 in the embodiment. As shown in FIG. 5, the administrator terminal 2 is a general type of computer having a housing 21 that includes an arithmetic processing unit 22 constructed of a CPU (Central Processing Unit), a main memory, etc., a storage unit (hard disc) 23 stored with data and software for the arithmetic processing, an I/O port 24, a communication control unit (CCU) 25, etc.

Input devices such as a keyboard, a mouse, a CD-ROM drive, etc., and output devices such as a display device, a printer, etc. are properly connected to the I/O ports 24.

The CCU 25 performs communications with other computers via the network.

The storage unit 23 is preinstalled with an operating system (OS) and application software (mail program).

The arithmetic processing unit 22 properly reads the OS and the application program from the storage unit 23 and executes the OS and the application software, and effects the arithmetic processing upon pieces of information inputted from the I/O ports 24 and from the CCU 25 and information read from the storage unit 23, thereby functioning as a security information receiving module and a security information presenting module. In the embodiment, the security information is received by an electronic mail, and the arithmetic processing unit 22 executes an e-mail receiving program, i.e., a so-called mail program (mailer), thereby functioning as the receiving module for receiving the security information and the presenting module for presenting the security information to the administrator.

Note that the user terminal 1 and the administrator terminal 2 in the embodiment are exemplified in a way that implements the functions of the respective modules by executing the software on the general type of computers as described above, and may, without being limited to this configuration, also be dedicated electronic devices constructed of dedicatedly designed electronic circuits (hardware) as the respective modules.

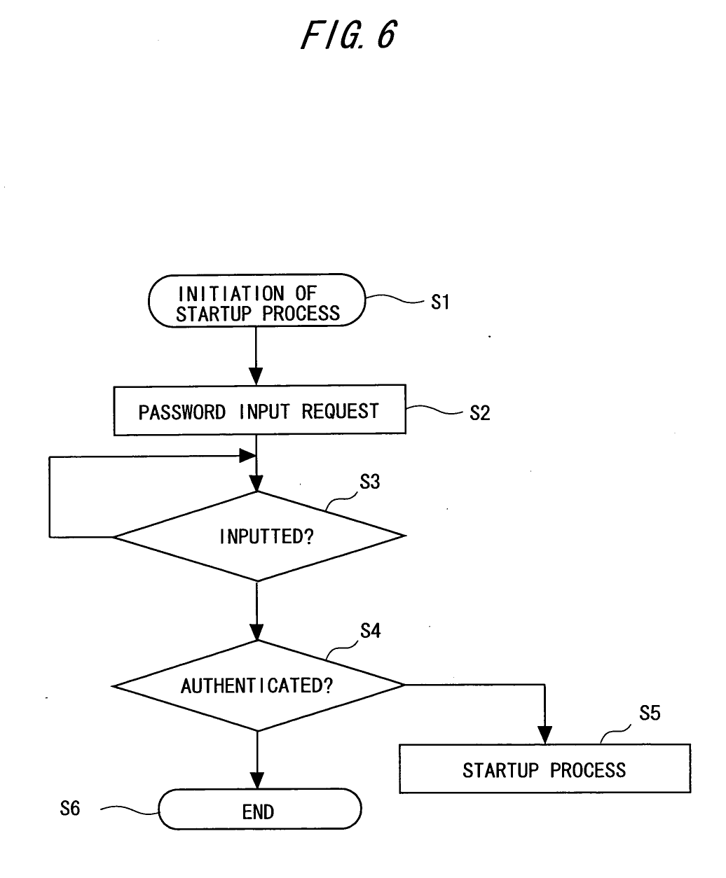

Next, a security information notifying method executed in the system 10 will be explained with reference to FIGS. 6 through 11.

As shown in FIG. 6, the user terminal 1, upon a startup operation such as pressing a power button and so forth, reads the BIOS and starts the startup process (step 1, which will hereinafter be abbreviated such as S1). The BIOS initializes predetermined devices such as the CPU, the display, the memory, the keyboard, etc. that are necessary for authenticating the password, and displays a password input request message on the display device (S2).

When the user inputs the password by operating the keyboard, the user terminal 1 compares the inputted password with a password registered beforehand on the CMOS, then authenticates the password if both of these passwords are coincident with each other, and continues the predetermined start up process (S3-S4). Through this authentication, the user terminal 1 reads the OS from the storage unit 13 serving as the startup device and executes the OS, thereby enabling a communication function based on the CCU 15 and application-software-based functions to be utilized.

On the other hand, if both of the passwords are not coincident in step 3, the user terminal 1 does not authenticate the password and terminates the startup process (S3, S5).

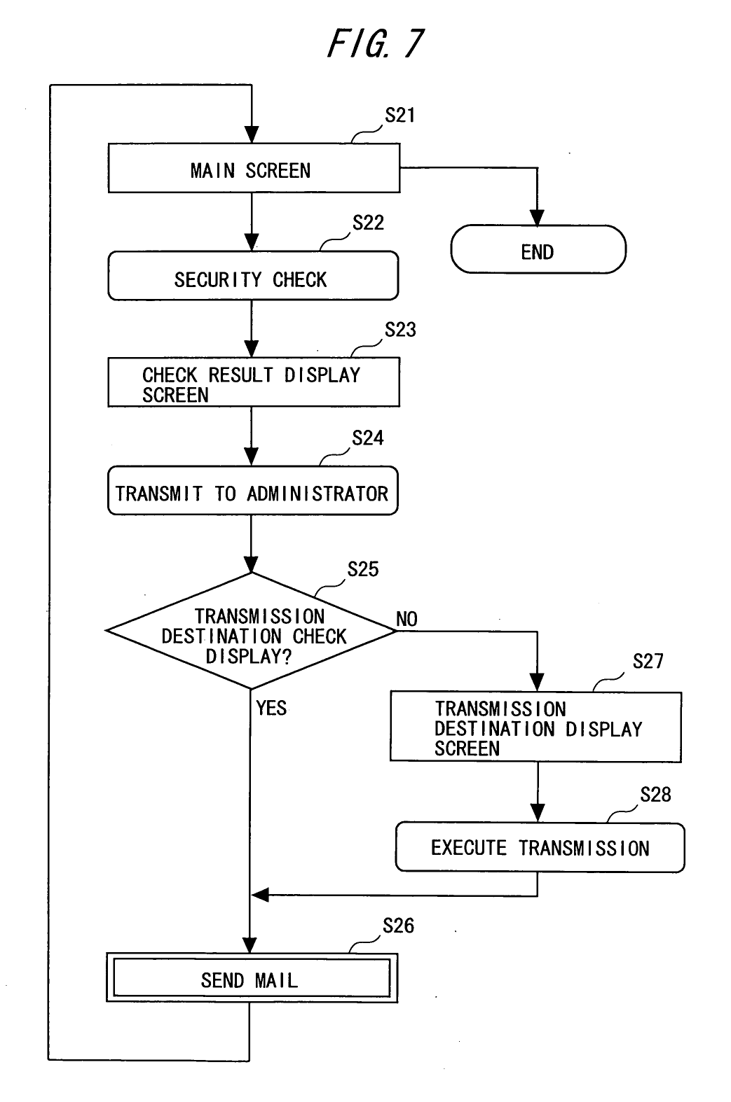

Then, the user terminal 1, after completion of the startup process, i.e., after starting up the OS, as shown in FIG. 7, executes a security information report process.

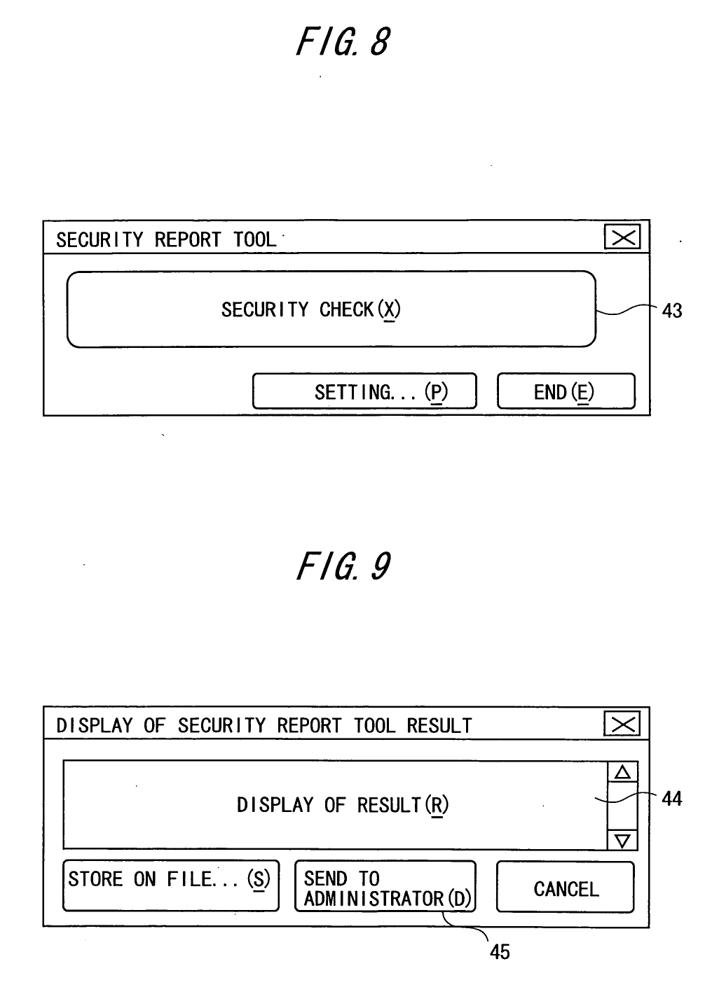

To begin with, when the user performs an operation of starting up a program for reporting the security information, the user terminal 1 displays a main screen on the display device as shown in FIG. 8 (S21).

When the user selects a [security check] button 43 on the main screen, the user terminal 1 checks the security, i.e., refers to the setting state of the password (S22), and displays a check result display screen as illustrated in FIG. 9 (S23).

When the user confirms a check result (password setting state) 44 and selects a [transmit-to-administrator] button 45, the user terminal 1 judges whether confirmation display of a transmission destination is required or not (S25). Note that the requirement or non-requirement for this confirmation display is previously registered on the storage unit 13, etc. by the user's selection. The user terminal 1 confirms this piece of registered information and, if the confirmation display is not required, sends the check result as the security information to the predetermined administrator terminal 2 (S26).

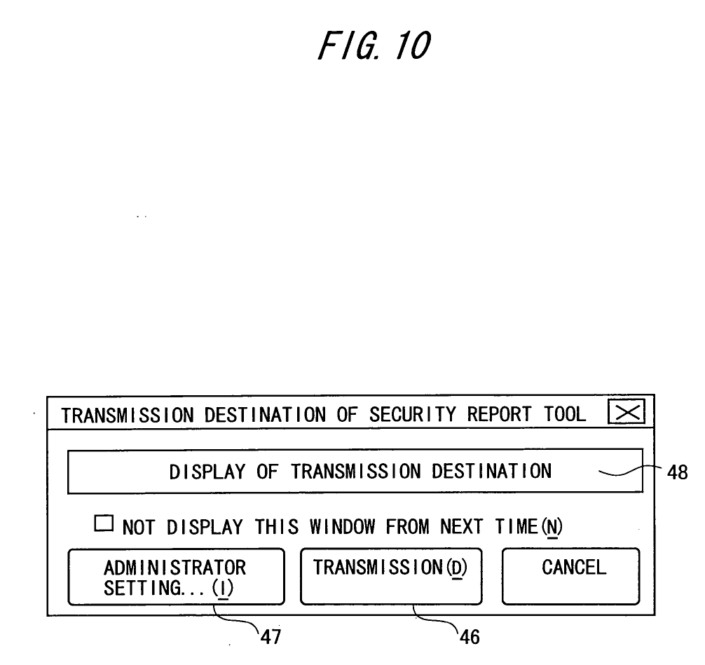

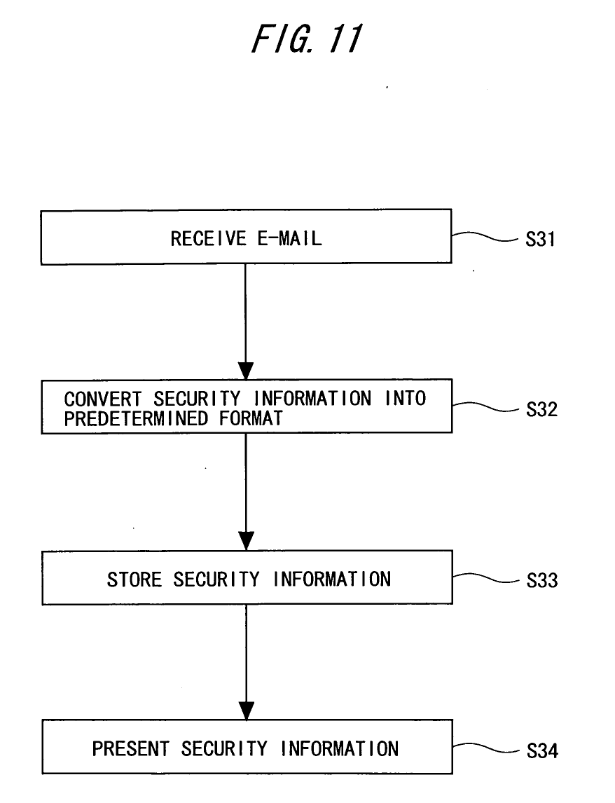

While on the other hand, if this confirmation display is required, the user terminal 1 displays a transmission destination display screen as shown in FIG. 10 (S27), and, when the user selects a [transmission] button 46 (S28), transmits the security information to the predetermined administrator terminal 2 (S26). Note that a transmission destination 48 may be information such as a mail address, an IP address, a computer name, etc. from which the administrator terminal 2 of the transmission destination can be specified.

It is simplicity that programs for the security check and transmitting the check result are implemented as application programs running on the OS but are not limited to this type of application programs.

Further, the following methods are given, for example, as processes for checking whether a BIOS password is set or not.

<Check of Setting State of Password>

(1) The control is transferred to the BIOS program from the application program, and the BIOS program refers to an area stored with the password and notifies the application program of a referred result (as to whether the password exists or not).

In the case of implementing the program as the general type of application running on the OS, methods for transferring the control to the BIOS program from the application program are given such as:

a method using software interruption,

a method based on a jump table in which an ingress address is provided in a specified address, and so on.

(2) When started up, the BIOS program executes a process of storing the existence or non-existence of the password in a specified memory address, and the application program refers to this specified memory address, thereby checking whether the password exists or not.

(3) Method Combining Methods (1) and (2)

The specified address in the method (2) is not preset, the control is transferred to the BIOS program from the application program by the method (1), and the BIOS program notifies the application program of a should-be-referred address as a return value thereof. Thereafter, the application program refers to the address, thereby checking whether the password exists or not.

(4) The BIOS program implements a function of judging the validity of the password transferred from the application program, the application program transfers a null character string or a Null value as a password to the BIOS in step 22, wherein a query about the validity is made. If a result of this query is not coincident, the application program judges that some password is designated.

For instance, APIs (Applications Programming Interfaces) for transferring the password to the BIOS from the application are given, for instance, as below.

BOOL Logon User (

LPTSTR lpszUsername, // a character string for designating a user's

name

LPTSTR lpszDomain, // a character string for designating Domain or the server

LPTSTR lpszPassword, // a character string for designating the password

DWORD dwLogonType, // this designates a type of log-on operation

DWORD dwLogonProvider, // this designates a log-on provider

PHANDLE phToken // a pointer to a variable for receiving token handle

<Report of Setting State of Password>

The user terminal 1, when instructed to transmit the setting state of the password as described above, adds a supplementary piece of information to this setting state and sets it as the security information, and sends the security information to the administrator terminal 2 by e-mail in step 26.

A program for transmitting this setting state (which will hereinafter be referred to also as a state report program) may execute the security check through the transmission of the security information (S21-S28), and may also execute up to generation of the security information, wherein the existing e-mail program may send the security information.

An e-mail address of the transmission destination (administrator) is set when installing the program for reporting the setting state. Further, the setting in preparation for a case where the administrator might be changed, is that the change can be made by designating an option on this state report program.

One example of an e-mail text to be transmitted is given as follows, however, a transmission format is not limited to this format, and the e-mail can be sent in a binary format other than a text format.

Form example:device identifying name, existence or non-existence of password, date/time

Data example:FMV0102352, 1, 2004/12/24 22:30

Herein, the device identifying name is a name for identifying the user terminal 1 on which the state report program runs. This name is set as a uniquely distinguishable name such as “product name plus manufacturing number”, etc. This setting is done when installing the state report program. Further, the setting in preparation for a case of being changed depending on convenience in terms of management is that the change is made by designating an option on the state report program.

The existence or non-existence of password represents the existence or non-existence of the password set in the BIOS, i.e., whether or not the setting is required to input the password when started up. The format is available if capable of distinguishing between the states such as enable/disable, 0/1 and o/x. Further, in the case of employing plural types of passwords such as “user password=o, administrator password=x”, the existence or non-existence thereof may also be indicated for every type.

Moreover, the date/time represents a date and time when the setting state was checked.

The state report program is started up on the day (date/time) such as first Monday, etc. in every month when the user needs the report that is predetermined in terms of the operation. Without being limited to this method, the state report program can be also automatically started up periodically on the predetermined date/time or in a predetermined period by use of scheduling software. Furthermore, in the case of automatically starting up this program, the security check and the transmission of the security information may also be done (S22, S26) by conducting neither displaying to the user nor checking (S21, S23, S24, S25, S27, S28), and so on. This enables the setting state to be reported without any burden on the user.

<Method of Receiving Security Information>

FIG. 11 is an explanatory diagram of a method by which the administrator terminal 2 receives the security information from each user terminal 1 in accordance with a receiving program.

It is simplicity that this receiving program is implemented as an application program running on the OS but is not limited to this type of program. The security information in the embodiment is transmitted by e-mail, and hence the receiving program does not need to be a program having a special requirement on condition that the receiving program is so-called mail software capable of receiving the e-mail.

As shown in FIG. 11, the administrator terminal 2 receives the e-mails from a mail server (unillustrated) (S31) and identifies a mail having the setting state among those mails. For example, on the occasion of creating the mail on the side of the user terminal, a title of the mail and a sender are inputted a specified character string beforehand, and the administrator terminal 2 identifies the mail containing the title or the specified character string of the sender among the received mails by use of a filtering function.

Next, the administrator terminal 2 converts the security information (which is the mail text in this example) of the identified mail into data in a predetermined format, e.g., a comma separated value (CSV) format (S32).

The administrator terminal 2 stores the CSV-formatted data on the memory or the storage unit 23 (S33).

The administrator terminal 2 reads the stored data through spreadsheet software, executes processing such as totaling, displaying a list, etc., then aggregates the data given from the plurality of user terminals 1 and displays the data on the display device (S34).

In this example, the mail text is CSV-formatted, whereby the security information can be processed by the existing software. It is, however, possible to change the format of the mail text into a different format for saving more of labor and to configure a dedicated program having a more complicated function in a way that searches through a personnel database, etc., with the received device identifying name used as a key.

As described above, according to the embodiment, the setting state of the password can be checked after starting up the OS, and the administrator comes to have no necessity of checking while being present at the startup of the user terminal each time and can be relieved from a burden.

Moreover, it is possible to provide the security information notifying system, the information processing device, the security information notifying method and the security information notifying program, wherein the password is authenticated before the communication function becomes usable, and the management is facilitated while ensuring the high security.

<Others>

The invention is not limited to only the illustrated examples given above and can be, as a matter of course, changed in a variety of forms in the range that does not deviate the gist of the invention.

In the embodiment, it is checked whether or not there is the setting for authenticating the password, however, there may also be taken such setting as to enable an updated state of the password to be checked.

Further, it may also be checked whether or not there is setting for authentication of not the password but biometric information of the user.

The disclosures of Japanese patent application No. JP2005-054802 filed on Feb. 28, 2005 including the specification, drawings and abstract are incorporated herein by reference.

What is claimed is:

1. An authentication setting information notifying system in which a user information device notifies an administrator information device of authentication setting information via a network,
the user information device comprising:
an authentication state referring module referring to a setting state of authentication of the user information device; and
a notifying module notifying a predetermined administrator device of a result of the reference as authentication setting information,
the administrator device comprising:
a receiving module receiving the authentication setting information; and
a presenting module presenting the authentication setting information to an administrator.

2. An authentication setting information notifying system according to claim 1, wherein the user information device further comprises:
an authentication module making authentication corresponding to the setting state of the authentication when started up; and
a startup control module executing a predetermined startup process when the authentication is conducted correctly by the authentication module.

3. An authentication setting information notifying system according to claim 2, wherein the authentication module makes the authentication for a period till a communication by the notifying module is enabled to perform since an onset of the startup.

4. An authentication setting information notifying system according to claim 2, wherein the authentication module and the startup control module operate based on BIOS,
the startup control module starts up an OS through a predetermined startup process, and
the authentication state referring module and the notifying module operate based on the OS or an application program running in cooperation with the OS.

5. An authentication setting information notifying system according to claim 1, wherein the receiving module receives the authentication setting information from the plurality of user information devices, and
the presenting module aggregates the authentication setting information given from the plurality of user information devices and presents the aggregated information to the administrator.

6. An authentication setting information notifying system according to claims 1, wherein the authentication of the user information device is an authentication of a password input by a user.

7. An authentication setting information notifying system according to claim 6, wherein the setting of the authentication of a password is done based on an updated state of the password.

8. An authentication setting information notifying system according to claims 1, wherein the authentication of the user information device is done based on biometric information of the user.

9. A user information device for notifying an administrator information device of authentication setting information via a network, comprising:
an authentication state referring module referring to a setting state of authentication of the user information device; and
a notifying module notifying a predetermined administrator device of a result of the reference as authentication setting information.

10. A user information device according to claim 9, further comprising:
an authentication module making authentication when started up, corresponding to the setting state of the authentication; and
a startup control module executing a predetermined startup process when the authentication is conducted correctly by the authentication module.

11. A user information device according to claim 10, wherein the authentication module makes the authentication for a period till a communication by the notifying module is enabled to perform since an onset of the startup.

12. A user information device according to claim 10, wherein the authentication module and the startup control module operate based on BIOS,
the startup control module starts up an OS through a predetermined startup process, and
the authentication state referring module and the notifying module operate based on the OS or an application program running in cooperation with the OS.

13. A user information device according to claim 9, wherein the authentication of the user information device is an authentication of a password input by a user.

14. A user information device according to claim 13, wherein the authentication of a password is done based on an updated state of the password.

15. A user information device according to claim 9, wherein the authentication of the user information device is done based on biometric information of the user.

16. An authentication setting information notifying method executed by a user information device connected to an administrator information device via a network, comprising steps of:
referring to a setting state of authentication of the user information device; and
notifying a predetermined administrator device of a result of the reference as authentication setting information.

17. An authentication setting information notifying method according to claim 16, further comprising steps of:
making authentication when started up, corresponding to the setting state of the authentication; and
executing a predetermined startup process when the authentication is conducted correctly.

18. An authentication setting information notifying program operated on a user information device connected to an administrator information device via a network, the program making the user information device execute steps of:
referring to a setting state of authentication of the user information device; and
notifying a predetermined administrator device of a result of the reference as authentication setting information.

19. An authentication setting information notifying program according to claim 18, further making the user information device execute steps of:
making authentication when started up, corresponding to the setting state of the authentication; and
executing a predetermined startup process when the authentication is conducted correctly.
